(19) United States
(12) Patent Application Publication
(10) Pub. No.: US 2009/0237352 A1
(43) Pub. Date: Sep. 24, 2009

(54) ELECTROPHORETIC DISPLAY UNIT

(75) Inventors: Atsushi Abe, Fujimi-cho (JP); Hiroshi Hirayama, Shiojiri-shi (JP); Wataru Ito, Chino-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/389,638

(22) Filed: Feb. 20, 2009

(30) Foreign Application Priority Data
Mar. 24, 2008 (JP) 2008-076014

(51) Int. Cl. G09G 3/34

(52) U.S. Cl. 345/107

(57) ABSTRACT

An electrophoretic display unit includes a first protective substrate, a second protective substrate, and an electrophoretic display panel disposed between the first and second protective substrates. The electrophoretic display panel includes an element board having a display region, an electrophoretic sheet which includes an electrophoretic layer, and a friction-reducing member which is the outermost layer of the electrophoretic display panel. The electrophoretic sheet faces the first protective substrate and is attached to the element board. The friction-reducing member faces the first protective substrate, and is made of a material that allows the coefficient of friction between the friction-reducing member and the first protective substrate to be less than or equal to the coefficient of friction between the element board and the second protective substrate.

### BACKGROUND

1. Technical Field

The present invention relates to an electrophoretic display unit.

2. Related Art

In recent years, electrophoretic display units have been used as display sections of displays such as electronic paper displays. The electrophoretic display units each contain an electrophoretic dispersion containing a liquid dispersion medium and electrophoretic particles dispersed therein and use that the distribution of the electrophoretic particles is varied by the application of an electric field to the electrophoretic dispersion and therefore optical properties of the electrophoretic dispersion are varied. Japanese Unexamined Patent Application Publication No. 2007-72127 discloses an electrophoretic display unit including an electrophoretic display panel and a protective member. The electrophoretic display panel includes an element board having a display region, an electrophoretic sheet attached to the display region, a moisture barrier sheet, and an impact-absorbing film. These components are retained in the protective member. The moisture barrier sheet and the impact-absorbing film are disposed on or above the electrophoretic sheet.

The protective member includes a support plate, a frame, and a surface protector. The frame laterally surrounds the electrophoretic display panel. The support plate supports the front surface of the element board. The surface protector covers the front surface of the electrophoretic sheet. The frame and the electrophoretic display panel are spaced from each other with a gap therebetween. The gap contains a cushion.

If a side portion of the electrophoretic display panel is subjected to shock, the electrophoretic display panel moves in a space in the protective member. Therefore, the shock applied to the electrophoretic display panel is less than the shocks applied to electrophoretic display panels abutting frames. The presence of the cushion prevents the electrophoretic display panel from colliding with the frame. This allows the electrophoretic display panel to have high impact resistance.

In the electrophoretic display unit, the front and rear surfaces of the electrophoretic display panel have different coefficients of friction. That is, the friction between the surface protector and the impact-absorbing film is higher than the friction between the element board and the support plate. Therefore, when the electrophoretic display panel is moved toward a side portion of the protective member, the element board and the electrophoretic sheet are subjected to different friction forces and therefore stresses are generated between layers disposed in the electrophoretic display panel. There is a problem in that the layers are stripped off by the stresses.

### SUMMARY

An advantage of an aspect of the invention is to provide an electrophoretic display unit having high impact resistance.

An electrophoretic display unit according to the present invention includes a first protective substrate, a second protective substrate, and an electrophoretic display panel disposed between the first and second protective substrates. The electrophoretic display panel includes an electrophoretic sheet which includes an electrophoretic layer and which faces the first protective substrate, an element board having a display region attached to the electrophoretic sheet, and a friction-reducing member which is the outermost layer located on the side of the electrophoretic sheet. The friction-reducing member is made of a material that allows the coefficient of friction between the friction-reducing member and the first protective substrate to be less than or equal to the coefficient of friction between the element board and the second protective substrate.

According to the present invention, the electrophoretic display panel includes the friction-reducing member, which is the outermost layer located on the side of the electrophoretic sheet, and the friction-reducing member is made of such a material that allows the coefficient of friction between the friction-reducing member and the first protective substrate to be less than or equal to the coefficient of friction between the element board and the second protective substrate; hence, when the electrophoretic display panel is moved in a protective member by shock, the friction between the electrophoretic display panel and the protective member can be reduced. The reduction of the friction therebetween allows the friction force applied to the electrophoretic display panel to be reduced. This prevents the breakage of the electrophoretic display panel and allows the electrophoretic display unit to have high impact resistance.

In the electrophoretic display unit, the friction-reducing member is disposed between the electrophoretic sheet and the first protective substrate.

Conventional electrophoretic display units have a problem that the friction against element boards is higher than the friction against electrophoretic sheets. On the other hand, in the electrophoretic display unit, the friction-reducing member is disposed between the electrophoretic sheet and the first protective substrate; hence, unlike the conventional electrophoretic display units, the friction against the electrophoretic sheet can be reduced. Therefore, the breakage of the electrophoretic display panel can be securely prevented.

In the electrophoretic display unit, the friction-reducing member overlies the electrophoretic sheet.

If the electrophoretic layer is partly broken, a broken portion of the electrophoretic layer cannot be used for display; hence, a measure for preventing the breakage of the electrophoretic layer has been demanded. According to the present invention, the friction-reducing member overlies the electrophoretic sheet; hence, friction force can be prevented from being applied to the electrophoretic sheet and therefore the breakage of the electrophoretic layer can be securely prevented.

In the electrophoretic display unit, the electrophoretic display panel further includes a third protective substrate overlying the electrophoretic sheet and the friction-reducing member overlies the third protective substrate.

The electrophoretic layer is susceptible to moisture changes and is readily damaged by impact. In the present invention, the friction-reducing member overlies the third protective substrate and has high moisture barrier properties and high impact resistance; hence, the electrophoretic sheet can be protected. In addition, the presence of the friction-reducing member, which overlies the third protective substrate, is effective in preventing friction force from being applied to the third protective substrate; hence, the electrophoretic sheet can be stably protected.

In the electrophoretic display unit, the friction-reducing member is positioned in contact with the first protective substrate.

According to the present invention, friction force can be prevented from being applied to all members disposed between the first protective substrate and the electrophoretic sheet because the friction-reducing member is positioned in contact with the first protective substrate.

In the electrophoretic display unit, the friction-reducing member is fixed to the electrophoretic display panel.

According to the present invention, the friction-reducing member and the electrophoretic display panel can be prevented from being misaligned with each other because the friction-reducing member is fixed to the electrophoretic display panel. Therefore, the electrophoretic display panel can be securely protected.

The electrophoretic display unit further includes a frame member laterally surrounding the electrophoretic display panel and a shock-absorbing member disposed between the electrophoretic display panel and the frame member.

According to the present invention, the shock applied to the electrophoretic display panel can be reduced when the electrophoretic display panel is laterally moved, because the electrophoretic display unit further includes the frame member, which laterally surrounds the electrophoretic display panel, and the shock-absorbing member, which is disposed between the electrophoretic display panel and the frame member. This allows the electrophoretic display unit to have enhanced impact resistance.

In the electrophoretic display unit, the shock-absorbing member abuts a side portion of the electrophoretic display panel.

According to the present invention, the transverse motion of the electrophoretic display panel is restricted because the shock-absorbing member abuts a side portion of the electrophoretic display panel. This allows the electrophoretic display unit to have enhanced impact resistance.

### BRIEF DESCRIPTION OF THE DRAWINGS

The invention will be described with reference to the accompanying drawings, wherein like numbers reference like elements.

FIG. 1 is a schematic plan view of an electrophoretic display unit according to an embodiment of the present invention.

FIG. 2 is a sectional view of the electrophoretic display unit taken along the line II-II of FIG. 1.

FIG. 3 is a sectional view of an electrophoretic display unit which includes no friction-reducing member and which hits a floor.

FIG. 4 is a sectional view of the electrophoretic display unit, according to the present invention, hitting a floor.

FIG. 5 is a modification of the electrophoretic display unit according to the present invention.

FIG. 6 is another modification of the electrophoretic display unit according to the present invention.

FIG. 7 is another modification of the electrophoretic display unit according to the present invention.

FIG. 8 is a sectional view of an electrophoretic display unit hitting something.

### DESCRIPTION OF EXEMPLARY EMBODIMENTS

Embodiments of the present invention will now be described with reference to the accompanying drawings.

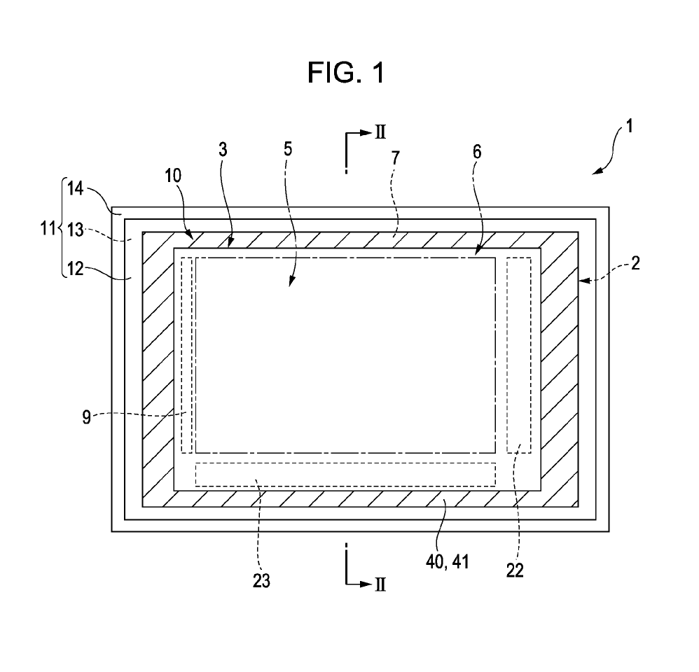

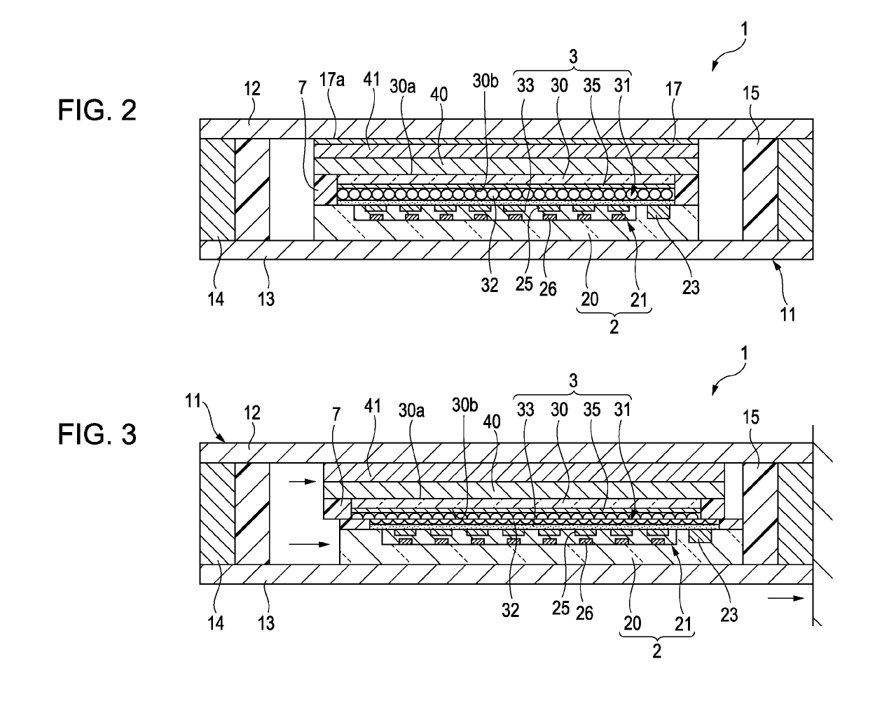

FIG. 1 is a schematic plan view of an electrophoretic display unit 1 according to an embodiment of the present invention. FIG. 2 is a sectional view taken along the line II-II of FIG. 1.

With reference to FIGS. 1 and 2, the electrophoretic display unit 1 includes an electrophoretic display panel 10 and protective member 11. The front surface of the electrophoretic display panel 10 is entirely covered with the electrophoretic display panel 10.

The electrophoretic display panel 10 includes an element board 2 and an electrophoretic sheet 3 attached thereto.

The electrophoretic display panel 10 has a display region 5 for displaying an image such as a still image or a video image. The display region 5 contains a plurality of pixels arranged in a matrix pattern. The pixels are independently addressable. The electrophoretic display panel 10 further has a non-display region 6 which extends around the display region 5 and on which no image is displayed. The non-display region 6 contains no pixel and has a first driving circuit element 22, a second driving circuit element 23, and terminals 24.

The element board 2 includes a substrate 20 and a driving layer 21 disposed thereon. The substrate 20 has a rectangular shape in plan view. Examples of the substrate 20 include inorganic substrates such as glass substrates, quartz substrates, silicon substrates, and gallium arsenide substrates; plastic substrates (resin substrates) such as polyimide substrates, polyethylene terephthalate (PET) substrates, polyethylene naphthalate (PEN) substrates, polymethyl methacrylate (PMMA) substrates, polycarbonate (PC) substrates, polyethersulfon (PES) substrates, and aromatic polyester (liquid crystal polymer) substrates; and similar substrates.

The substrate 20 has a region corresponding to the display region 5. The driving layer 21 overlies the region. The driving layer 21 includes pixel electrodes 25, switching elements 26, data lines (not shown), and scanning lines (not shown). The pixel electrodes 25 and the switching elements 26 are each connected to a corresponding one of the pixels. The data and scanning lines are connected to the switching elements 26. The driving layer 21 substantially overlaps with the display region 5 in plan view. The first and second driving circuit element 22 and 23 are disposed in the non-display region 6, which surrounds the driving layer 21. The first and second driving circuit element 22 and 23 are electrically connected to the data and scanning lines and supply signals to the driving layer 21. The terminals 24 are arranged on an end portion (a right end portion) of the element board 2 and are connected to the first and second driving circuit element 22 and 23 through wires extending on the element board 2. The terminals 24 are connected to an external circuit substrate, which is not shown. The substrate 20 slidably abuts the protective member 11.

The electrophoretic sheet 3 includes a transparent substrate 30, a common electrode 35, an electrophoretic layer 31, and an adhesive layer 33.

The transparent substrate 30 supports the electrophoretic layer 31. The transparent substrate 30 has a rectangular shape and is made of a material, such as PET, PES, or PC, having high light transmittance. The transparent substrate 30 has an outer surface 30a serving as a screen of the electrophoretic display unit 1.

The transparent substrate 30 has an inner surface 30b. The common electrode 35 extends over the inner surface 30b thereof. The common electrode 35 is made of a conductive material, such as indium tin oxide (ITO), having high light transmittance and is connected to the element board 2 through a through conductive member 9.

The electrophoretic layer 31 contains a plurality of microcapsules 32.

The microcapsules 32 are substantially spherical, contain an electrophoretic dispersion, and have a uniform diameter of about 50 to 100 μm. Examples of a material for forming the walls of the microcapsules 32 include Arabic gum-gelatin composites and polymers such as urethane resins and urea resins. The electrophoretic dispersion is sealed in the microcapsules 32 and contains a plurality of electrophoretic particles and a liquid dispersion medium for dispersing the electrophoretic particles.

Examples of the liquid dispersion medium include water, alcohol solvents, esters, ketones, aliphatic hydrocarbons, alicyclic hydrocarbons, aromatic hydrocarbons, halohydrocarbons, carboxylates, and oils. These compounds may be used alone or in combination or used in combination with a surfactant.

The electrophoretic particles may be organic or inorganic particles (polymer or colloid particles) that migrate electrophoretically in the liquid dispersion medium under the influence of an electric potential. In particular, the electrophoretic particles may contain a black pigment such as carbon black or aniline black, a white pigment such as titanium dioxide, an azo pigment such as monoazo pigments, a yellow pigment such as isoindolinone, a red pigment such as quinacridone red, a blue pigment such as phthalocyanine blue, or a green pigment such as phthalocyanine green. These pigments may be used alone or in combination. These pigments may contain a charge control agent containing particles of an electrolyte, a surfactant, metal soap, resin, rubber, oil, varnish, or compound; a dispersant such as a titanium coupling agent, an aluminum coupling agent, or a silane coupling agent; a lubricant; an stabilizer; and/or the like as required.

The microcapsules 32 preferably contain two types of electrophoretic particles made of carbon black, which is a black pigment, or titanium dioxide, which is a white pigment: one type of electrophoretic particles are negatively charged and the other type of electrophoretic particles are positively charged. The microcapsules 32 may contain another type of electrophoretic particles. Alternatively, the microcapsules 32 may contain only one type of electrophoretic particles such that an image or the like can be displayed in such a manner that these electrophoretic particles are caused to migrate electrophoretically to the common electrode 35 or the pixel electrodes 25.

The adhesive layer 33 is made from a heat-curable adhesive acting as a binder. The adhesive preferably has high affinity to the walls of the microcapsules 32, high adhesion to the common electrode 35 and the pixel electrodes 25, and high insulating properties. The cured adhesive is preferably elastic.

The transparent substrate 30 is overlaid with a moisture barrier sheet 40. The moisture barrier sheet 40 has substantially the same size as that of the transparent substrate 30 in plan view, has a thickness of about 0.1 mm, and is light-transmissive. The moisture barrier sheet 40 may include a light-transmissive film made of, for example, polyethylene terephthalate or polyethylene naphthalate and an inorganic barrier layer disposed thereon. The moisture barrier sheet 40 is attached to the electrophoretic sheet 3 with, for example, a double-faced adhesive tape or a highly light-transmissive adhesive layer (not shown) made from a photocurable adhesive.

The moisture barrier sheet 40 is overlaid with a shock-absorbing film 41. The shock-absorbing film 41 has substantially the same size as that of the transparent substrate 30 and that of the moisture barrier sheet 40 in plan view and is a highly light-transmissive film made of, for example, an acrylic or silicone-based shock-absorbing material. The shock-absorbing film 41 is fixed to the moisture barrier sheet 40 with, for example, a double-faced adhesive tape or a transparent adhesive layer (not shown). A sealing member 7 is disposed between the shock-absorbing film 41 and the element board 2. The sealing member 7 surrounds the electrophoretic sheet 3, the moisture barrier sheet 40, and the shock-absorbing film 41 when viewed from above. Examples of a material for forming the sealing member 7 include epoxy resins, acrylic resins, and silicone resins.

The shock-absorbing film 41 is overlaid with a friction-reducing member 17. The friction-reducing member 17 is made of a material, such as polyethylene terephthalate, polycarbonate, or an acrylic resin, having high light-transmittance such that a surface 17a of the friction-reducing member 17 has a coefficient of friction less than or equal to that between the electrophoretic sheet 3 and a support plate 13 described below. The friction-reducing member 17 is fixed on the shock-absorbing film 41. Therefore, the element board 2, the electrophoretic sheet 3, the moisture barrier sheet 40, the shock-absorbing film 41, and the friction-reducing member 17 are unified.

The surface 17a of the friction-reducing member 17 slidably abuts the protective member 11. The substrate 20 of the element board 2 also slidably abuts the protective member 11. Therefore, the friction-reducing member 17 and the above members unified with the friction-reducing member 17 can be moved in the protective member 11 in such a state that the surface 17a of the friction-reducing member 17 is in contact with the protective member 11.

The protective member 11 includes a surface-protecting sheet 12, the support plate 13, a frame member 14, and a shock-absorbing member 15.

The surface-protecting sheet 12 is located on the side of the electrophoretic sheet 3, which is disposed in the electrophoretic display panel 10, and is in contact with the surface 17a of the friction-reducing member 17. The surface-protecting sheet 12 is not fixed to the friction-reducing member 17. The surface-protecting sheet 12 contains an acrylic or silicone-based shock-absorbing material and has a thickness of about 0.5 mm. The surface-protecting sheet 12 has high impact resistance, is resistant to bending stress, and is flexible because of the presence of this shock-absorbing material.

The support plate 13 is located on the side of the element board 2, which is disposed in the electrophoretic display panel 10, and is positioned so as to overlap with the surface-protecting sheet 12 in plan view. The support plate 13, as well as the surface-protecting sheet 12, contains an acrylic or silicone-based shock-absorbing material and has a thickness of about 0.5 mm.

The frame member 14 laterally surrounds the electrophoretic display panel 10. A marginal portion of the frame member 14 is sandwiched between the surface-protecting sheet 12 and the support plate 13. The frame member 14 is made of an organic material such as an acrylic resin or PET and is tightly bonded to a marginal portion of the surface-protecting sheet 12 and a marginal portion of the support plate 13 so as to fix these marginal portions. The frame member 14 may be fixed to the surface-protecting sheet 12 and the support plate 13 by laser welding or with an adhesive, which is not shown. If this adhesive is used, this adhesive preferably contains a highly moisture-proof material and has high moisture barrier properties.

The shock-absorbing member 15 is disposed between the electrophoretic display panel 10 and the frame member 14 and is in contact with an inner surface of the frame member 14. Examples of a material for forming the shock-absorbing member 15 include acrylic resins and silicone resins. The shock-absorbing member 15 can absorb the shock applied to a portion surrounding the electrophoretic display panel 10. A gap is present between the electrophoretic display panel 10 and the shock-absorbing member 15 in plan or sectional view. In this embodiment, the gap is an air layer (air gap). The presence of the gap allows the electrophoretic display unit 1 to have increased impact resistance.

The electrophoretic layer 31 is sandwiched between the element board 2 and the transparent substrate 30 and is sealed with the surface-protecting sheet 12, the support plate 13, and the frame member 14. The electrophoretic layer 31 is sensitive to moisture. Since the electrophoretic layer 31 is sealed as described above, moisture can be securely prevented from entering the electrophoretic layer 31. The electrophoretic display panel 10 is in contact with the surface-protecting sheet 12 and the support plate 13. This allows the electrophoretic display panel 10 to have increased impact resistance.

The operation of the electrophoretic display unit 1 is briefly described below.

When voltages are applied between the common electrode 35 and the pixel electrodes 25 such that the voltage of the common electrode 35 is relatively high, positively charged black electrophoretic particles are moved in the microcapsules 32 toward the pixel electrodes 25 by Coulomb's force and negatively charged white electrophoretic particles are moved in the microcapsules 32 toward the common electrode 35 by Coulomb's force. This results in that the white electrophoretic particles gather at portions of the microcapsules 32 that are close to the transparent substrate 30, thereby displaying white, which is the color of the white electrophoretic particles, on the display region 5 of the electrophoretic display unit 1.

In contrast, when voltages are applied between the common electrode 35 and the pixel electrodes 25 such that the voltage of the pixel electrodes 25 is relatively high, negatively charged white electrophoretic particles are attracted toward the pixel electrodes 25 by Coulomb's force and positively charged black electrophoretic particles are attracted toward the common electrode 35 by Coulomb's force. This results in that the black electrophoretic particles gather at portions of the microcapsules 32 that are close to the transparent substrate 30, thereby displaying black, which is the color of the black electrophoretic particles, on the display region 5 of the electrophoretic display unit 1.

When the friction-reducing member 17 is not present in the electrophoretic display unit 1, the friction between the surface-protecting sheet 12 and the shock-absorbing film 41 is higher than the friction between the element board 2 and the support plate 13. If a side portion of the electrophoretic display unit 1 hits a floor, the electrophoretic display panel 10 is moved toward the side portion thereof by the shock caused by hitting the floor as shown in FIG. 3. In this moment, the element board 2 and electrophoretic sheet 3 of the electrophoretic display panel 10 are subjected to different friction forces and therefore a stress is caused between layers of the electrophoretic display panel 10 or in, for example, the electrophoretic layer 31, which contains the microcapsules 32. Hence, there is a problem in that the electrophoretic layer 31 is broken by the stress.

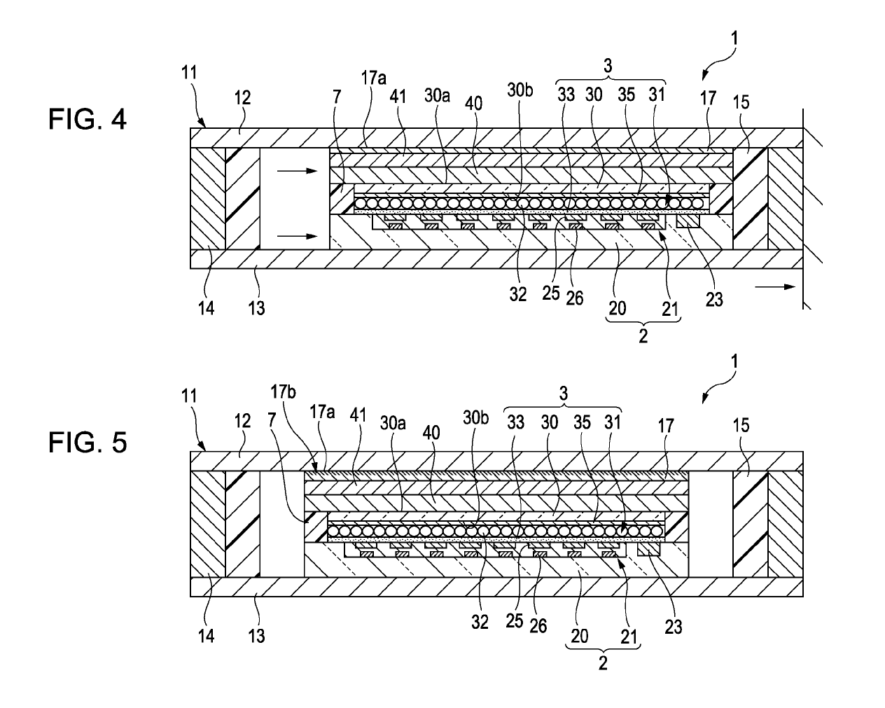

According to this embodiment, the electrophoretic display panel 10, however, includes the friction-reducing member 17. The friction-reducing member 17 is the outermost layer located on the side of the electrophoretic sheet 3, which faces the surface-protecting sheet 12, and is made of the above-mentioned material, which allows the coefficient of friction between the friction-reducing member 17 and the surface-protecting sheet 12 to be less than or equal to that between the element board 2 and the support plate 13. Therefore, when the electrophoretic display panel 10 is moved in the protective member 11 by a shock or the like as shown in FIG. 4, the friction between the electrophoretic display panel 10 and the protective member 11 is low. The low friction therebetween allows the electrophoretic display panel 10 to slide in the protective member 11, because the surface 17a of the friction-reducing member 17 and a surface of the element board 2 serve as sliding surfaces. Therefore, the friction force applied to the electrophoretic display panel 10 can be reduced and stresses caused between layers of the electrophoretic display panel 10 can be also reduced. This prevents the breakage of the electrophoretic display panel 10 and allows the electrophoretic display unit 1 to have high impact resistance.

In this embodiment, the friction-reducing member 17 is disposed between the electrophoretic sheet 3 and the surface-protecting sheet 12; hence, the electrophoretic sheet 3 has reduced friction as compared to a conventional one. This is effective in preventing the breakage of the electrophoretic display panel 10.

The microcapsules 32, which are contained in the electrophoretic layer 31, are susceptible to moisture changes and are readily damaged by a shock. In this embodiment, the moisture barrier sheet 40, which has high moisture barrier properties, and the shock-absorbing film 41, which has high impact resistance, are arranged on the electrophoretic sheet 3 in that order and the friction-reducing member 17 is disposed on the shock-absorbing film 41; hence, friction stresses can be prevented from being applied to the moisture barrier sheet 40 and the shock-absorbing film 41. This allows the electrophoretic sheet 3 to be stably protected. The friction-reducing member 17 is positioned in contact with the surface-protecting sheet 12; hence, friction stresses can be prevented from being applied to all the members disposed between the surface-protecting sheet 12 and the electrophoretic sheet 3.

According to this embodiment, the friction-reducing member 17 is fixed to the shock-absorbing film 41, which is included in the electrophoretic display panel 10; hence, the friction-reducing member 17 and the electrophoretic display panel 10 can be prevented from being misaligned with each other. This allows the electrophoretic display panel 10 to be securely protected.

The technical scope of the present invention is not limited to this embodiment. Various modifications can be made within the scope of the present invention.

The friction-reducing member 17, which is a characteristic element in this embodiment, can be modified as described below.

FIG. 5 is a sectional view of a modification of the electrophoretic display unit 1 and corresponds to FIG. 2, which is used to describe the above embodiment.

The coefficient of friction between the friction-reducing member 17 and the surface-protecting sheet 12 may be reduced in such a manner that the surface 17a of the friction-reducing member 17 is treated as shown in FIG. 5. The surface 17a may be treated with, for example, Teflon® or the like such that a surface layer 17b is formed. Alternatively, the surface 17a may be smoothed by polishing.

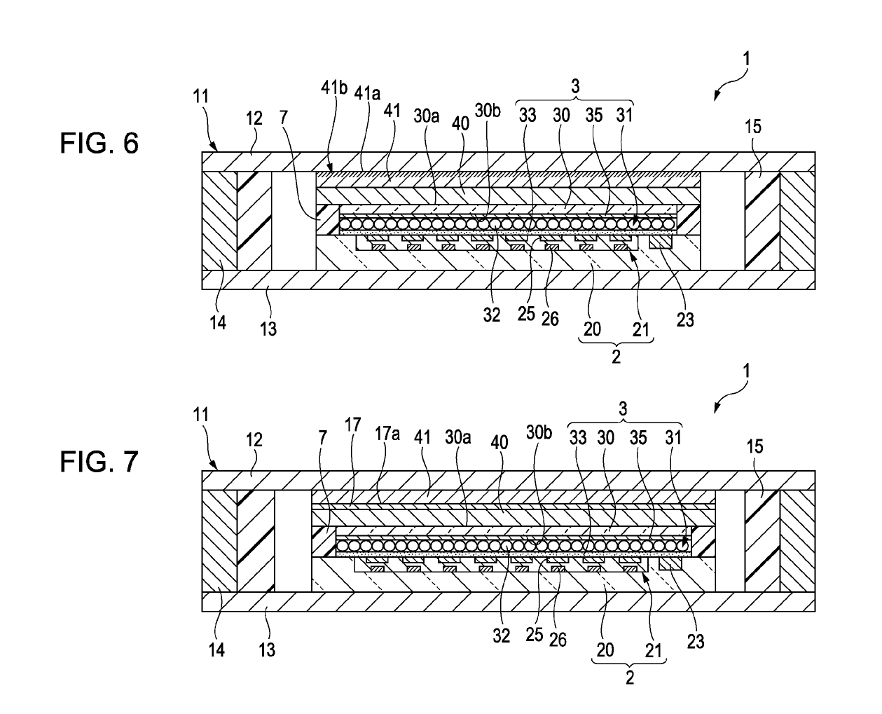

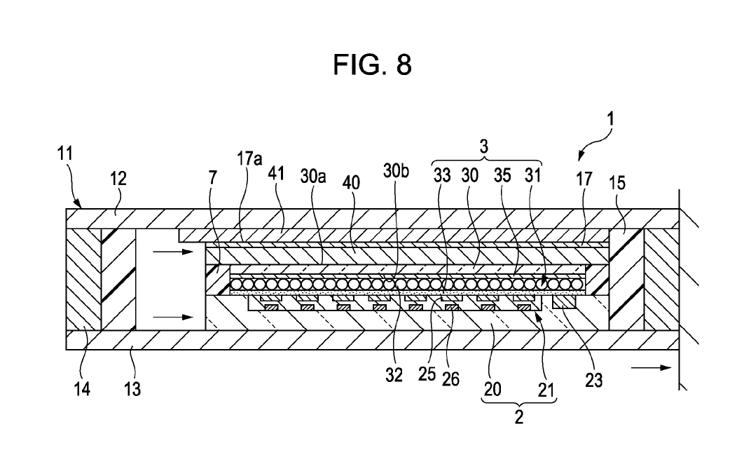

FIG. 6, as well as FIG. 5, is a sectional view of another modification of the electrophoretic display unit 1.

In the above embodiment, the friction-reducing member 17 is disposed on the shock-absorbing film 41. The present invention is not limited to this configuration. As shown in FIG. 6, the shock-absorbing film 41 may be used to reduce friction instead of the friction-reducing member 17 in such a manner that the shock-absorbing film 41 is surface-treated with, for example, Teflon® or the like such that a surface layer 17b is formed thereon or in such a manner that a surface 41a of the shock-absorbing film 41 is smoothed by polishing. Alternatively, the moisture barrier sheet 40 or the transparent substrate 30 may be surface-treated in the same manner as above so as to serve as a friction-reducing member.

FIG. 7, as well as FIGS. 5 and 6, is a sectional view of another modification of the electrophoretic display unit 1.

In the above embodiment, the friction-reducing member 17 is disposed on the shock-absorbing film 41 as described above. The present invention is not limited to this configuration. As shown in FIG. 7, the friction-reducing member 17 may be disposed between the shock-absorbing film 41 and the moisture barrier sheet 40. In this configuration, the friction-reducing member 17 is fixed to the moisture barrier sheet 40 and is not fixed to the shock-absorbing film 41. Therefore, the element board 2, the electrophoretic sheet 3, the moisture barrier sheet 40, and the friction-reducing member 17 are unified.

For this configuration, if a side portion of the electrophoretic display unit 1 hits a floor, the unified members move in the protective member 11 toward the floor because the friction between the surface 17a of the friction-reducing member 17 and the shock-absorbing film 41 is low. Therefore, stresses can be prevented from being applied to portions between the unified members and in particular, a stress can be prevented from being applied to the electrophoretic layer 31.

The friction-reducing member 17 may be disposed between the electrophoretic sheet 3 and the moisture barrier sheet 40. In this configuration, the friction-reducing member 17 is fixed to the transparent substrate 30 of the electrophoretic sheet 3 and is not fixed to the moisture barrier sheet 40. For this configuration, even if a side portion of the electrophoretic display unit 1 hits a floor, stresses can be prevented from being applied to portions between the unified members including the electrophoretic layer 31.

In the above embodiment, the friction-reducing member 17 is located on the side of the electrophoretic sheet 3, which is disposed in the electrophoretic display panel 10. Another friction-reducing member 17 may be placed on the side of element board 2. This friction-reducing member 17, which is locate on the side of the element board 2, is made of the same material as that used to form that friction-reducing member 17, which is located on the side of the electrophoretic sheet 3. Therefore, when electrophoretic display panel 10 is moved in the protective member 11, the friction generated on that friction-reducing member 17, which is located on the side of the electrophoretic sheet 3, is substantially equal to the friction generated on this friction-reducing member 17, which is located on the side of the element board 2. This securely prevents stresses from being generated between layers in the electrophoretic display panel 10.

In the above embodiment, the air layer (air gap) is disposed between the electrophoretic display panel 10 and the shock-absorbing member 15. The present invention is not limited to this configuration. The shock-absorbing member 15 may be directly bonded to the electrophoretic display panel 10. In this case, even if a side portion of the electrophoretic display unit 1 hits a floor, the shock-absorbing member 15 restricts the motion of the electrophoretic display panel 10 and therefore can securely prevent a stress from being applied to the electrophoretic display panel 10 in cooperation with the friction-reducing member 17.

The entire disclosure of Japanese Patent Application No.2008-076014, filed Mar. 24, 2008 is expressly incorporated by reference herein.

What is claimed is:

1. An electrophoretic display unit comprising:
a first protective substrate;
a second protective substrate; and
an electrophoretic display panel disposed between the first and second protective substrates, the electrophoretic display panel including:
an element board having a display region;
an electrophoretic sheet which includes an electrophoretic layer and which is disposed between the first protective substrate and the element board, the electrophoretic sheet being attached to the element board; and
a friction-reducing member which is the outermost layer of the electrophoretic display panel, the friction-reducing member facing the first protective substrate, the friction-reducing member being made of a material that allows the coefficient of friction between the friction-reducing member and the first protective substrate to be less than or equal to the coefficient of friction between the element board and the second protective substrate.

2. The electrophoretic display unit according to claim 1, wherein the friction-reducing member is disposed between the electrophoretic sheet and the first protective substrate.

3. The electrophoretic display unit according to claim 1, wherein the friction-reducing member overlies the electrophoretic sheet.

4. The electrophoretic display unit according to claim 1, wherein the electrophoretic display panel further includes a third protective substrate overlying the electrophoretic sheet and the friction-reducing member overlies the third protective substrate.

5. The electrophoretic display unit according to claim 1, wherein the friction-reducing member is positioned in contact with the first protective substrate.

6. The electrophoretic display unit according to claim 1, wherein the friction-reducing member is fixed to the electrophoretic display panel.

7. The electrophoretic display unit according to claim 1, further comprising a frame member laterally surrounding the electrophoretic display panel and a shock-absorbing member disposed between the electrophoretic display panel and the frame member.

8. The electrophoretic display unit according to claim 7, wherein the shock-absorbing member abuts a side portion of the electrophoretic display panel.
